(19) United States
(12) Patent Application Publication
(10) Pub. No.: US 2023/0088536 A1
(43) Pub. Date: Mar. 23, 2023

(54) NETWORK CONTRACTS IN COMMUNICATION PACKETS

(71) Applicant: Huawei Technologies Co., Ltd., Shenzhen (CN)

(72) Inventors: Richard LI, Fremont, CA (US); Lijun DONG, San Diego, CA (US); Kiran MAKHIJANI, Los Gatos, CA (US)

(73) Assignee: Huawei Technologies Co., Ltd., Shenzhen (CN)

(21) Appl. No.: 18/059,647

(22) Filed: Nov. 29, 2022

Related U.S. Application Data
(63) Continuation of application No. PCT/US2020/061562, filed on Nov. 20, 2020.
(60) Provisional application No. 63/032,556, filed on May 30, 2020.

(51) Int. Cl. H04L 41/5009; H04L 41/0896

(52) U.S. Cl. CPC H04L 41/5009; H04L 41/0896

(57) ABSTRACT

An efficient structure and methodology are provided for communicating in a network using a contract implemented in a packet or frame. In various embodiments, a user can generate a contract clause having a constraint for communicating in the network, and determine a communication layer at which to process the constraint during communication in the network. The user device can insert the contract clause in a position in a packet corresponding to the communication layer and can transmit the packet from the user device. In various embodiments, a network node that receives a packet can identify a contract clause in a packet and can process a constraint from the contract clause. The network node can track performance of the constraint and provide accountability in response to the tracking of the performance with respect to terms associated with the constraint in the contract clause.

### CROSS-REFERENCE TO RELATED APPLICATIONS

This application is a continuation of International Application No. PCT/US2020/061562, filed 20 Nov. 2020, entitled “Network Contracts in Communication Packets,” which claims priority under 35 U.S.C. 119(e) from U.S. Provisional Application Ser. No. 63/032,556, entitled “Method and Apparatus Providing Contracts in Network Datagrams,” filed 30 May 2020, the benefit of priority of each of which is claimed herein, and which applications are incorporated herein by reference in their entirety.

### TECHNICAL FIELD

The present disclosure is related to communications, and, in particular, to methods and apparatus to embed network contracts in communication packets in data communication systems in which network contracts represent a structured agreement between the end users/applications and the network.

### BACKGROUND

Applications require different types of network services to connect to end users. The current Internet is based on a best-effort service paradigm, in other words, there are no mechanisms to ensure or verify that the service is provided accurately according to the application requirements. For example, there is a lack of assurances to meet application-specified throughput or latency, and a lack of reporting that the packet was delivered late due to congestion in an identified part of the network. This has several consequences such as service degradation, lack of visibility, and packet loss and retransmission. With respect to service degradation, a service in the network may begin to under-perform, then continues to perform at a degraded level because the network has no information about the expected performance of the application. While end users continue to experience poor quality of service, the network operators are unable to determine the root cause of the poor performance of service due to lack of visibility into specific problems in the networks. In the best-effort networks, congestion control mechanisms are managed by the end hosts without much information about network congestion. When a network is congested, packet losses can occur arbitrarily, leading to retransmissions from end hosts without taking corrective measures in the networks. In some cases retransmitted packets may be too late, such as in cloud-assisted autonomous driving with a programmable logic controller (PLC) operated from the cloud, requiring data between the remote controller and the local device to be delivered at a precise time and with extremely high reliability.

The role of the networks is growing from traditional applications in text, voice, and video where delays and losses are easily tolerated to autonomous machine-based communications that do not tolerate either delay or losses. Such services are referred to as high-precision communication (HPC) services. HPC service refers to those network services that provide in-time and on-time service delivery guarantees. In many such cases, guarantees of low packet loss will also be required. Meanwhile, high-volume immersive media and holographic applications require high bandwidth guarantees. Furthermore, the ability to identify problems in network conditions or/and take corresponding actions is also necessary. This requires ways to coordinate with the network so that guarantees of time, bandwidth, and packet losses can be met. The best-effort networks lack means to coordinate with the end user applications to fulfill any of the HPC or new media demands.

### SUMMARY

It is an object of various embodiments to provide an efficient architecture and methodology for implementing a contract into a packet to define network services used and provided by a network as well as conditions for the service assurance. “Network Contract,” as a formal service specification, is introduced that provides service-specific parameters, assessment criteria, accountability on failure, and other elements associated with the services. A user device can generate a contract clause having a constraint for communicating in the network, where the constraint corresponds to a communication layer at which to process the constraint during communication in the network. The contract clause can be inserted in a position in a packet corresponding to the communication layer and the packet can be transmitted from the user device. The constraint can specify one or more network resources to be used or one or more metrics to be met during the communication in the network. The contract clause can include a term specifying an operation type, a threshold of the operation type, and an action to be taken in response to attainment or exceeding the threshold. The Summary is not intended to identify key or essential features of the claimed subject matter, nor is it intended to be used to limit the scope of the claimed subject matter.

According to a first aspect of the present disclosure, there is provided a user device operable to communicate in a network. The user device includes a memory storing instructions and one or more processors in communication with the memory. The one or more processors execute the instructions to generate a contract clause having a constraint for communicating in the network and to determine a communication layer at which to process the constraint during communication in the network. The executed instructions include inserting the contract clause in a position in a packet corresponding to the communication layer and transmitting the packet from the user device.

In a first implementation form of the user device according to the first aspect as such, the one or more processors are operable to execute the instructions to: process a second contract clause in a received packet from a second network, originating from another device, according to a communication layer in which the second contract clause is embedded in the received packet; and perform a function specified in the second contract clause.

In a second implementation form of the user device according to the first aspect as such, the constraint specifies a network resource to be used or a metric to be met during the communication in the network.

In a third implementation form of the user device according to the first aspect as such or any preceding implementation form of the first aspect, the contract clause includes a term specifying a parameter associated with the constraint, a threshold for the parameter, and an action to be taken in response to measuring the parameter and determining that the measured parameter exceeds a threshold.

In a fourth implementation form of the user device according to the first aspect as such or any preceding implementation form of the first aspect, the contract clause encapsulates service functionality including customization, assurance, accountability, or billability.

In a fifth implementation form of the user device according to the first aspect as such or any preceding implementation form of the first aspect, the communication layer is between a physical and a media access layer, between the media access layer and a network layer, or between the network layer and a transport layer.

In a sixth implementation form of the user device according to the first aspect as such or any preceding implementation form of the first aspect, the packet includes one or more additional contract clauses.

In a seventh implementation form of the user device according to the first aspect as such or any preceding implementation form of the first aspect, the one or more processors execute the instructions to insert the one or more additional contract clauses into positions corresponding to one or more different communication layers.

In an eighth implementation form of the user device according to the first aspect as such or any preceding implementation form of the first aspect, the network includes different domain networks in an end-to-end communication path, and the packet includes one or more additional contract clauses. Each additional clause is directed to a service in a respective different domain network.

In an ninth implementation form of the user device according to the first aspect as such or any preceding implementation form of the first aspect, the one or more processors are operable to, before communication, have agreed with the different domain networks to fulfill contracts in the networks when packets from the user device pass through.

In a tenth implementation form of the user device according to the first aspect as such or any preceding implementation form of the first aspect, the one or more processors are operable to, before communication, have agreed with a global network controller of the different domain networks through which the packets transit. The global network controller has a network subcontract with each of the domain networks on behalf of the user device.

In an eleventh implementation form of the user device according to the first aspect as such or any preceding implementation form of the first aspect, the contract clause is part of a network contract specified for a group of packets, a flow, or a group of flows.

According to a second aspect of the present disclosure, there is provided a computer-implemented method of a user device communicating in a network. The computer-implemented method includes generating a contract clause having a constraint for communicating in the network and determining a communication layer at which to process the constraint during communication in the network. The contract clause is inserted in a position in a packet corresponding to the communication layer. The packet is transmitted from the user device.

In a first implementation form of the computer-implemented method according to the second aspect as such, the method includes processing a second contract clause in a received packet from a network, originating from another device, according to a communication layer in which the second contract clause is embedded in the received packet; and performing a function specified in the second contract clause.

In a second implementation form of the computer-implemented method according to the second aspect as such, the constraint specifies a network resource to be used or a metric to be met during the communication in the network.

In a third implementation form of the computer-implemented method according to the second aspect as such or any preceding implementation form of the second aspect, the contract clause includes a term specifying a parameter associated with the constraint, a threshold for the parameter, and an action to be taken in response to measuring the parameter and determining that the measured parameter exceeds a threshold.

In a fourth implementation form of the computer-implemented method according to the second aspect as such or any preceding implementation form of the second aspect, the contract clause encapsulates service functionality including customization, assurance, accountability, or billability.

In a fifth implementation form of the computer-implemented method according to the second aspect as such or any preceding implementation form of the second aspect, the communication layer is between a physical and a media access layer, between the media access layer and a network layer, or between the network layer and a transport layer.

In a sixth implementation form of the computer-implemented method according to the second aspect as such or any preceding implementation form of the second aspect, the packet includes one or more additional contract clauses.

In a seventh implementation form of the computer-implemented method according to the second aspect as such or any preceding implementation form of the second aspect, the one or more additional contract clauses are inserted in positions corresponding to one or more different communication layers.

In an eighth implementation form of the computer-implemented method according to the second aspect as such or any preceding implementation form of the second aspect, the network includes different domain networks in an end-to-end communication path, and the packet includes one or more additional contract clauses, with each additional clause directed to a service in a respective different domain network.

In a ninth implementation form of the computer-implemented method according to the second aspect as such or any preceding implementation form of the second aspect, the method includes, before communication, agreeing with the different domain networks to fulfill contracts in the networks when packets from the user device pass through.

In a tenth implementation form of the computer-implemented method according to the second aspect as such or any preceding implementation form of the second aspect, the method includes, before communication, agreeing with a global network controller of the different domain networks through which the packets transit, the global network controller having a network subcontract with each of the domain networks on behalf of the user device.

In an eleventh implementation form of the computer-implemented method according to the second aspect as such or any preceding implementation form of the second aspect, the contract clause is part of a network contract specified for a group of packets, a flow, or a group of flows.

According to a third aspect of the present disclosure, there is provided a network node operable to communicate in a network. The network node includes a memory storing instructions and one or more processors in communication with the memory. The one or more processors execute the instructions to identify a contract clause in a packet received at the network node in a communication from a device and process a constraint from the contract clause. Performance of the constraint for the communication of the packet from the device to the network node is tracked. Data is generated based on the tracking of performance with respect to one or more terms associated with the constraint. The data is inserted into metadata of the contract clause in the packet or inserted into a second packet and the second packet transmitted from the network node to one or more entities.

In a first implementation form of the network node according to the third aspect as such, the data is a result of a determination of a degraded status of performance.

In a second implementation form of the network node according to the third aspect as such or any preceding implementation form of the third aspect, the data includes an amount of credit for billing.

In a third implementation form of the network node according to the third aspect as such or any preceding implementation form of the third aspect, the data is a result of a determination of an enhanced status of performance, with the data including an amount of increase in billing.

In a fourth implementation form of the network node according to the third aspect as such or any preceding implementation form of the third aspect, the one or more processors are operable to: access a database containing network contracts; determine a validity status of the contract clause based on contract data obtained from accessing the database; and inform a network controller or the device with respect to the determined validity status.

In a fifth implementation form of the network node according to the third aspect as such or any preceding implementation form of the third aspect, the one or more processors are operable to validate the contract clause when the network node is an edge node of a network in a communication path from the device.

In a sixth implementation form of the network node according to the third aspect as such or any preceding implementation form of the third aspect, the processing of the constraint from the contract clause is conducted at a communication layer dependent upon position of the contract clause in the packet.

According to a fourth aspect of the present disclosure, there is provided a computer-implemented method of a network node communicating in a network. The computer-implemented method includes receiving a packet at the network node in a communication from a device and identifying a contract clause in the received packet. A constraint from the contract clause is processed. The computer-implemented method includes tracking performance of the constraint in the communication of the received packet to the network node, and generating data based on the tracking of performance with respect to one or more terms associated with the constraint in the contract clause. The data is inserted into metadata of the contract clause in the received packet or the data is inserted into a second packet and the second packet is transmitted from the network node to one or more entities.

In a first implementation form of the computer-implemented method according to the fourth aspect as such, generating data based on the tracking of performance includes generating the data from determining a degraded status of performance.

In a second implementation form of the computer-implemented method according to the fourth aspect as such or any preceding implementation form of the fourth aspect, the data includes an amount of credit for billing.

In a third implementation form of the computer-implemented method according to the fourth aspect as such or any preceding implementation form of the fourth aspect, generating data based on the tracking of performance includes generating the data from determining an enhanced status of performance, with the data including an amount of increase in billing.

In a fourth implementation form of the computer-implemented method according to the fourth aspect as such or any preceding implementation form of the fourth aspect, the computer-implemented method includes: accessing a database containing network contracts; determining a validity status of the contract clause based on contract data obtained from accessing the database; and informing a network controller or the device with respect to the determined validity status.

In a fifth implementation form of the computer-implemented method according to the fourth aspect as such or any preceding implementation form of the fourth aspect, the computer-implemented method includes validating the contract clause at the network node when the network node is an edge node of a network in a communication path from the device.

In a sixth implementation form of the computer-implemented method according to the fourth aspect as such or any preceding implementation form of the fourth aspect, processing the constraint from the contract clause is conducted at a communication layer dependent upon a position of the contract clause in the packet.

According to a fifth aspect of the present disclosure, there is provided a network node. The network node includes a memory storing instructions and one or more processors in communication with the memory. The one or more processors execute the instructions to direct at least a portion of a packet, received at the network node in a communication from a device, to one or more processing modules of the network node for one or more communication layers of the packet.

Using the one or more processing modules at each communication layer, it is determined as to whether a contract is at the respective communication layer. A contract clause in the contract, determined to be in one of the communication layers of the packet, is identified and a constraint of the contract clause is determined. An action is executed with respect to the packet, corresponding to the determined constraint.

In a first implementation form of the network node according to the fifth aspect as such, in response to determining the constraint in the contract clause, the one or more processors are operable to: track performance of the constraint in the communication of the packet from the device to the network node; generate data based on the tracking of performance with respect to one or more terms associated with the constraint; and insert the data into metadata of the contract clause in the packet or insert the data into a second packet and transmit the second packet from the network node to one or more entities.

In a second implementation form of the network node according to the fifth aspect as such or any preceding implementation form of the fifth aspect, the one or more processors are operable to: access a database containing network contracts; determine a validity status of the contract clause based on contract data obtained from accessing the database; and inform a network controller or the device with respect to the determined validity status.

In a third implementation form of the network node according to the fifth aspect as such or any preceding implementation form of the fifth aspect, the one or more processors are operable to inform a network controller or the device that the constraint cannot be met.

In a fourth implementation form of the network node according to the fifth aspect as such or any preceding implementation form of the fifth aspect, the one or more processors are operable to: determine an alternative contract with one or more associated terms; embed the alternative contract in a return packet; and transmit the return packet directed to an originating device of the contract with respect to the packet received in the communication.

According to a sixth aspect of the present disclosure, there is provided a computer-implemented method of a network node operating in a network. The computer-implemented method includes receiving a packet at the network node in a communication from a device and directing at least a portion of the packet to one or more processing modules of the network node for one or more communication layers of the packet. The computer-implemented method includes determining, using the one or more processing modules at each communication layer, whether a contract is at the respective communication layer. A contract clause in the contract, determined to be in one of the communication layers of the packet, is identified, and a constraint of the contract clause is determined. An action is executed with respect to the packet, corresponding to the determined constraint.

In a first implementation form of the computer-implemented method according to the sixth aspect as such, the method includes, in response to determining the constraint in the contract clause, tracking performance of the constraint in the communication of the packet from the device to the network node; generating data based on the tracking of performance with respect to one or more terms associated with the constraint; and inserting the data into metadata of the contract clause in the packet or inserting the data into a second packet and transmitting the second packet from the network node to one or more entities.

In a second implementation form of the computer-implemented method according to the sixth aspect as such or any preceding implementation form of the sixth aspect, the method includes: accessing a database containing network contracts; determining a validity status of the contract clause based on contract data obtained from accessing the database; and informing a network controller or the device with respect to the determined validity status.

In a third implementation form of the computer-implemented method according to the sixth aspect as such or any preceding implementation form of the sixth aspect, the method includes informing the network controller or the device that the constraint cannot be met.

In a fourth implementation form of the computer-implemented method according to the sixth aspect as such or any preceding implementation form of the sixth aspect, the computer-implemented method includes: determining an alternative contract with one or more associated terms; embedding the alternative contract in a return packet; and transmitting the return packet directed to an originating device of the contract with respect to the packet received in the communication.

According to a seventh aspect of the present disclosure, there is provided a non-transitory computer-readable medium storing instructions for a user device communicating in a network, that when executed by one or more processors, cause the one or more processors to perform operations. The operations include generating a contract clause having a constraint for communicating in the network and determining a communication layer at which to process the constraint during communication in the network. The operations include inserting the contract clause in a position in a packet corresponding to the communication layer and transmitting the packet from the user device.

According to an eighth aspect of the present disclosure, there is provided a non-transitory computer-readable medium storing instructions for a network node communicating in a network, that when executed by one or more processors, cause the one or more processors to perform operations. The operations include receiving a packet at the network node in a communication from a device and identifying a contract clause in the received packet. A constraint from the contract clause is processed. Performance of the constraint in the communication of the received packet to the network node is tracked. Data is generated based on the tracking of performance with respect to one or more terms associated with the constraint in the contract clause. The data is inserted into metadata of the contract clause in the received packet or the data is inserted into a second packet and the second packet is transmitted from the network node to one or more entities.

According to a ninth aspect of the present disclosure, there is provided a non-transitory computer-readable medium storing instructions for a network node operating in a network, that when executed by one or more processors, cause the one or more processors to perform operations. The operations include receiving a packet at the network node in a communication from a device and directing at least a portion of the packet to one or more processing modules of the network node for one or more communication layers of the packet. The operations include determining, using the one or more processing modules at each communication layer, whether a contract is at the respective communication layer, and identifying a contract clause in the contract determined to be in one of the communication layers of the packet. A constraint of the contract clause is determined, and an action is executed, with respect to the packet, corresponding to the determined constraint.

According to a tenth aspect of the present disclosure, there is a user device that can be implemented to communicate in a network using contracts embedded in packets. The user device can include a means for generating a contract clause having a constraint for communicating in the network and a means for determining a communication layer at which to process the constraint during communication in the network. The user device can include a means for inserting the contract clause in a position in a packet corresponding to the communication layer and a means for transmitting the packet from the user device.

According to an eleventh aspect of the present disclosure, there is a network node that can be implemented to process received packets having embedded contracts in the packets. The network node includes a means for identifying a contract clause in a packet received at the network node in a communication from a device and a means for processing a constraint from the contract clause. The network node includes a means for tracking performance of the constraint for the communication of the packet from the device to the network node and a means for generating data based on the tracking of performance with respect to one or more terms associated with the constraint in the contract clause. The network node also includes a means for inserting the data into metadata of the contract clause in the received packet or inserting the data into a second packet. The network node includes a means for transmitting the second packet from the network node to one or more entities.

According to a twelfth aspect of the present disclosure, there is a network node that can be implemented to process received packets having embedded contracts in the packets. The network node includes a means for directing at least a portion of a packet, received at the network node in a communication from a device, to one or more processing modules of the network node for one or more communication layers of the packet, and a means for determining whether a contract is at the respective communication layer, using the one or more processing modules at each communication layer. The network node includes a means for identifying a contract clause in the contract determined to be in one of the communication layers of the packet and a means for determining a constraint of the contract clause. The network node also includes a means for executing an action, with respect to the packet, corresponding to the determined constraint.

Any one of the foregoing examples may be combined with any one or more of the other foregoing examples to create a new embodiment in accordance with the present disclosure.

### BRIEF DESCRIPTION OF THE DRAWINGS

The drawings illustrate generally, by way of example, but not by way of limitation, various embodiments discussed in the present document.

FIG. 1 illustrates an example system, associated with various embodiments.

FIG. 2 shows four example packet formats that include a network contract, associated with various embodiments.

FIG. 3 shows four example formats that further illustrate different positioning of a contract in a frame or packet, according to an example embodiment.

FIG. 4 illustrates examples of a basic structure for a contract to be embedded in a communication flow, according to an example embodiment.

FIG. 5 illustrates an embodiment of an example method of transmitting a contract from an application provider to an application server, according to an example embodiment.

FIG. 6 is a flow diagram of example operations on a packet by a network node, according to an example embodiment.

FIG. 7 illustrates an example end-to-end contract setup with individual network service providers, according to an example embodiment.

FIG. 8 illustrates an embodiment of an example end-to-end contract setup with providers established through a global network service (GNS) manager proxy, according to an example embodiment.

FIG. 9 illustrates an example of end-to-end contract validation and execution, according to an example embodiment.

FIG. 10 is a flow diagram of features of an example method of a user device communicating in a network, according to an example embodiment.

FIG. 11 is a flow diagram of features of an example method of a network node communicating in a network, according to an example embodiment.

FIG. 12 is a flow diagram of features of an example method of a network node operating in a network, according to an example embodiment.

FIG. 13 shows an example node, according to an example embodiment.

FIG. 14 shows an example computing system, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the embodiments, and it is to be understood that other embodiments may be utilized, and that structural, logical, mechanical, and electrical changes may be made. The following description of example embodiments is, therefore, not to be taken in a limited sense.

The functions or algorithms described herein may be implemented in software in an embodiment. The software may comprise computer-executable instructions stored on computer-readable media or computer-readable storage device such as one or more non-transitory memories or other type of hardware-based storage devices, either local or networked. Further, such functions correspond to modules, which may be software, hardware, firmware, or any combination thereof. Multiple functions may be performed in one or more modules as desired, and the embodiments described are merely examples. The software may be executed on a digital signal processor, application-specific integrated circuit (ASIC), a microprocessor, or other type of processor operating on a computer system, such as a personal computer, server or other computer system, turning such computer system into a specifically programmed machine.

Machine-readable non-transitory media, such as computer-readable non-transitory media, includes all types of computer readable media, including magnetic storage media, optical storage media, and solid state storage media and specifically excludes signals. The software can be installed in and sold with the devices that handle contracts embedded in packets or frame for communication as taught herein. Alternatively, the software can be obtained and loaded into such devices, including obtaining the software via a disc medium or from any manner of network or distribution system, including, for example, from a server owned by the software creator or from a server not owned but used by the software creator. The software can be stored on a server for distribution over the Internet, for example.

Specific information carried by a best-effort service delivery network other than the user payload is the address of the receiving entity. It bears no information about the characteristics of the application (as per network metrics) and therefore has no expectation of meeting those characteristics. To improve upon best-effort response, today's Internet provides some support through QoS technologies in the data layer and the control layer. These mechanisms allow an application to either provide a service level that it needs to be mapped to (DiffServ) or pre-allocate resources in the network to acquire low latency or prescribed bandwidth (IntServ). A main issue with IntServ is that it is a low level, two-pass request-reservation setup method. DiffServ does not adapt to changing behaviors of applications.

Communication functions of a telecommunication or computing system are characterized and standardized using a layered model for processing in which a communication system is partitioned into layers. A layer serves the layer above it and is served by the layer below it. For example, a seven-layer model can include different layers referred to as a physical layer, a data link layer, a network layer, a transport layer, a session layer, presentation layer, and an application layer. A layered model can be referred to in terms of number layers such as layer 1, layer 2, layer 3, etc. A layer referred to as L.5, where L is an integer, is an intermediate layer between layer L and layer (L+1). Layer 1.5 means between a physical layer and a media access layer. Layer 2.5 means between the media access layer and a network layer. Layer 3.5 means between the network layer and a transport layer.

The QoS deployments are limiting due to lack of incentives associated with enforcement of the service, either between an end user and a service provider or even between two peering networks. Service agreements are defined at the business operations level using service level agreements (SLAs). A SLA is an agreement between a service provider and a customer that identifies both the services required and the expected level of service, which agreement can vary based on the providers, services, and industries involved. SLAs determine the minimally acceptable service delivery targets. As of today, there is no formal specification that translates a SLA to a QoS. Manual translations are made to provide aggregated and long-term statistical service guarantees. Specific service delivery targets only assess satisfactory delivery over a period of time, which are not sufficient for HPC type of latency-sensitive of applications. This QoS model carries insufficient service-specific information. Further, service-specific information is not the only missing component of packets. Additional components such as fulfillment criteria, performance measurements, assessments and fulfillment incentives and disincentives are not carried. What is then desired are solutions that bridge the gap from business level SLAs to QoS and provide accurate service delivery guarantees.

All this leads to the following conclusion: in conventional approaches, an end user has no control over determining the outcome of service delivery—whether user-data was delivered as expected, within time, or where the bottlenecks for the service are. Similarly, a network operator has no control to prove to an end user what effort was made to deliver the user-data, where the user-data may be a packet, a flow, or a group of packets. In a nutshell, a packet in conventional approaches does not carry enough meaningful information that allows networks to implement new capabilities such as those described by high-precision communications, among others.

In various embodiments, a vehicle is provided called a “New Internet Protocol (IP) Contract” or a “Network Contract,” which serves as a structured agreement between end users/applications and a network to implement new network capabilities and services. A network contract is also referred to as a “contract” herein. Some of these capabilities are defined in ITU-T Focus Group on Network 2030's deliverable. The purpose of a contract is to define the network services used by applications, provided by the network as well as the conditions for the service assurance agreement. A network contract is a formal service specification that supports parameters, assessment criteria, accountability on failure to deliver, and several other elements associated with services. In addition to failure to deliver various levels of service, accountability can include incentives to network providers for exceeding expectations in delivery and can include no action taken when delivery is within terms of the contract.

As the name suggests, a contract is a formal specification of service arrangement between two or more parties. Such a specification can represent all variations, aspects, or elements of the services in a consistent manner regardless of their implementation. The parties (initiating or processing a contract) can include an application, a network application, and an end user, where any of these parties can define terms and elements of the contract. The parties can also include inter-network Internet service providers (ISPs) that may be included in the network. A contract may be specified for a single packet, a group of packets, a flow, or a group of flows. It extends the data plane at any layer to carry the service component. In other words, one or more contracts may be carried at any layer at or below a network layer, depending on the parties involved to carry out the agreement.

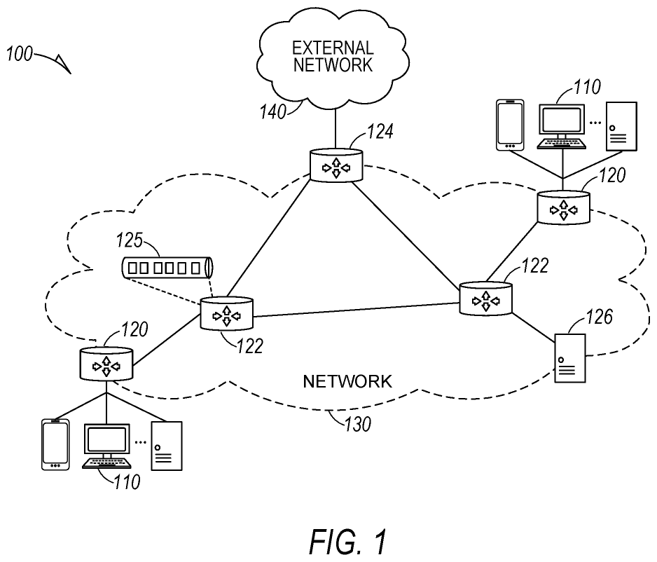

FIG. 1 illustrates an example system 100 in which embodiments of the disclosure may be implemented. The system 100 includes routers 120, 122, and 124. In an embodiment, the routers 122 are intermediate routers. Computing devices 110 connect to a network 130 via routers 120 to access resources provided by the network 130. The computing devices 110 may be virtually any type of general-purpose or specific-purpose computing device. For example, these computing devices 110 may be user devices such as desktop computers, laptop computers, tablet computers, display devices, cameras, printers, Internet of Things (IoT) devices, wearable computing devices, mobile devices, or smartphones. However, in a data center environment, these computing devices may be server devices such as application server computers, virtual computing host computers, or file server computers. Moreover, the computing devices 110 may be individually configured to provide computing, storage, and/or other suitable computing services.

The network 130 may include a plurality of network devices that facilitate the access of content by the computing devices 110. Each of the plurality of network devices may comprise one of a router, a switch, a server, a database server, a hub, a firewall, an intrusion detection/prevention (IDP) device and/or any other type of networking equipment or device that facilitates the transfer of data to and from the computing devices 110. The network 130 includes routers 120, 122 and 124, which communicate using various protocols, such as the Border Gateway Protocol and the Internet Control Message Protocol, in order to exchange routing, network configuration information, and other information. In an embodiment, the routers communicate using a new internet protocol (IP).

The network 130 may be a local area network (“LAN”), such as a token ring or Ethernet network, a virtual local area network (“VLAN”), or another type of network. The network 130 may comprise one or more wired or wireless links. For example, the network 130 may be an Ethernet network that comprises one or more Ethernet cables. In another example, the network 130 may be a Wireless Fidelity (“Wi-Fi”) network that uses wireless radio transmissions to communicate information. In another example, the network 130 may be a mobile network. Although shown as a single network 130, the network 130 may comprise any number of interconnected networks, either public or private, in which the various networks interconnect to form one or more virtual networks.

The network 130 provides a variety of resources that may be accessed by the computing devices 110. In the example of FIG. 1, the network 130 includes a content server 126 that stores or otherwise sources content, which refers to any data commonly transmitted and/or stored within a network, such as web-based applications, images, documents, web pages, video data, audio data such as voice, web-based games, scripts, or any other type of network-based content. The network 130 may support multicast techniques to improve the delivery efficiency of data transmitted with the network 130. In an embodiment, the network 130 supports the new IP to improve latency and guarantee data packet delivery, as discussed herein, where the new IP includes embedded contracts in packets or frames. The network 130 may also connect to a variety of other types of devices (e.g., file servers, printers, telephones, and e-mail and other application servers). The network 130 is also shown coupled to an external network 140 (e.g., the Internet) via the router 124. The external network 140 can be a public network that may include, for example, one or more client computing devices. The external network 140, such as a public network, may provide access to web servers, application servers, public databases, media servers, end user devices, and many other types of network resource devices and content.

The network 130 may transmit content to the computing devices 110 through routers 120 using one or more packet-based protocols, such as an Internet Protocol (IP)/Transmission Control Protocol (TCP) or the new IP. In this respect, the network 130 may support the transmission of data via discrete data units, often referred to as “packets.” As a result, the network 130 may be referred to as a “packet-based” or “packet switched” network. Network traffic delivered by the network 130 may be classified according to a number of categories. For instance, the content server 126 may stream live video to one of the computing devices 110 through the routers 120. Packets that transmit such video may be classified as streaming multimedia packets and may require a guaranteed bandwidth to provide an acceptable user experience. The content server 126 may also send web pages to one of the computing devices 110 using hypertext transport protocol (HTTP) packets. As another example, information exchanged by the routers 120, 122, and 124 may be categorized as HPC services. Information categorized as HPC requires, for example, a particular QoS, such as latency or throughput, which may be defined at the granularity of a packet, a group of packets, or a flow. Taking latency as an example, a latency guarantee in HPC services refers to the network needing to ensure the delivery of a packet, a group of packets, or all packets in a flow within a bounded time frame. When messages are specified with a same deadline, then the latency guarantee is ensured at the flow level. If each message is specified with an independent deadline, the latency guarantee is ensured at the data packet level. Thus, various categories of network traffic may require varying levels of network performance.

The routers 120, 122, and 124 receive, analyze, and classify data packets to assign the data packets to a suitable priority level. In addition to classifying data packets, the routers 120, 122, and 124 process the received and classified data packets according to their priority level. In this manner, the routers 120, 122, and 124 implement aspects of the QoS guarantees provided by the network 130. In addition, based on information received from other devices in the system 100, the routers 120, 122, and 124 determine the appropriate route through the system for each received data packet and forwards the data packet accordingly. For example, a contract specification may detail an end-to-end latency requirement for a data packet that traverses the network 130.

The routers 120, 122, and 124 may each include one or more queues 125 configured to store data packets as they arrive at intermediate nodes, such as the routers 122. The queues 125 typically include a queuing algorithm, which is usually implemented at the router level. In particular, output queues process the data packets that have been enqueued to await their turn to be forwarded or routed to the appropriate output port or interface.

A datagram is a basic transfer unit associated with a packet-switched network. A datagram only has a header and a user payload. The network can only use the header to forward packets. An end user or an application has no control over determining the outcome of service delivery—whether application data can be delivered or was delivered as expected and with given constraints. Existing network headers do not have a means to propagate this information out. Similarly, a network operator has no control to prove to an end-user application or share what effort was made to deliver the information.

A contract is a new and independent component in a datagram. A new datagram can include at least a header, a contract, and a user payload. By using contracts, a mechanism to communicate application-specific requirements to a network and/or across networks is made possible.

A frame/packet can carry a contract between an application and a network. The network, via network nodes such as routers or switches, fulfills the contract. The frame/packet can have a layering header, a contract, and a payload. The contract, in this arrangement, can provide for high-precision communications, user network interface (UNI), in-band signaling, high-precision telemetry, and user-defined networking. The contract can provide for HPC services such as, but not limited to, lossless networking guarantee, throughput guarantee, and latency guarantee. For example, a lossless networking guarantee provides for no packet loss. If there is packet loss, the user of the network can be given a compensation for failure to provide lossless networking. The amount of compensation can be a variable amount tied to the amount of packet loss. The data for the compensation can be, for example, collected at network nodes as x number of points reimbursed to an accounting service.

An example of a throughput guarantee is a requirement of a specific amount of throughput, for example but not limited to 12 Gbps. For example, such a contract may include a term stating that, if the throughput is not met, the user of the network can be given a compensation for failure to provide the guaranteed throughput. The amount of compensation can be a variable amount tied to deviation from the agreed upon specific amount of throughput. The contract term within the packet can specify that the throughput can change to another value from a time x or on receipt of the network node processing the packet. For example, a packet flow can have a throughput of 12 Gbps with the throughput changing to 5 Mbps from time x (or now—receipt of the current network node processing the packet).

The latency guarantee, for example, can be related to in-time performance, on-time performance, or coordinated performance. For example, an agreed latency guarantee can include a term such as the packet arrives at x absolute time sharp, that is, no sooner and no later. Another example term can include that the packet arrives in a certain amount of time, that is, must arrive at a destination in x ms since it was transmitted from source. An example amount of time can be, but is not limited to, 35 ms.

The high-precision telemetry functionality that can be provided by a contract in a packet can allow for tracking packets in a particular flow to determine, among other things, whether the packets are reaching their destination on time and whether throughput of the packets is not changing. The presence of the contract in the packet allows tracking at network nodes as the packets flow through these nodes. Per contract item (CI), if an anomaly occurs, a report of the anomaly can be provided to the sender.

The user-defined networking functionality that can be provided by contract in a packet can allow a user application to designate particular service-provider domains for the packets to flow through, which provides for preferred path routing (PPR). This user-defined networking functionality provides application-specific programmability that allows processing of packets based on application-specific requirements using one or more network functions installed at some of the network nodes in the selected routing path.

There are several elements that can be associated with a contract in the framework of a communications packet. One element is the positioning of the contract in a packet. The contract may be located at the beginning, end, or in a position along the packet with a layered header. A packet may carry more than one contract at different locations in the packet. A second element is the contract structure that can include two parts: a constraint and a term. While different services can express their network resource requirements in conventional approaches, any corresponding service violation behavior is not explicit. In current IP based networks, it is not formally described. The contract structure embedded in packets is different from SLAs. SLAs are contracts defined at business level for different services and networks. In addition, there are different SLAs with different parties. Consequently, end-to-end (E2E) SLAs are hard to track and it is hard to isolate the parts where violations occurred. A third element, associated with a contract in a packet, is that the packet contract provides an overall clarification on completely embedding service (installation, operation, incentive, verification) cycle in the data path.

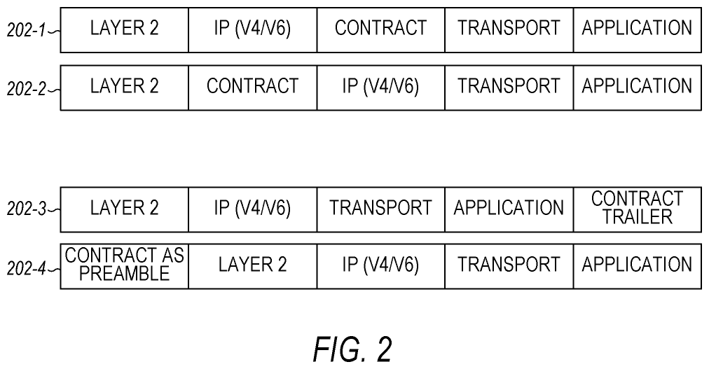

FIG. 2 shows embodiments of four example packet formats 202-1, 202-2, 202-3, and 202-4 that include a network contract. Each of the packet formats 202-1, 202-2, 202-3, and 202-4 include a layer 2 header, an IP (V4/V6) header, a transport header, and a payload for an application, in addition to the contract. A presence of a contract is embodied into such new packet formats, which may take any format depending upon implementation details. The contracts in packet formats 202-1 and 202-2 are between the preamble provided by the layer 2 header and the trailer provided by the application. The packet format 202-3 has the contract as the preamble in this format. The packet format 202-4 has the contract as the trailer in this format. A contract may be located between Layer 2 and Layer 3, between Layer 3 and Layer 4, or at other places subject to implementation details. However, it may well be a payload trailer or a preamble in a protocol agnostic manner. Especially at the lower levels, this type of flexibility allows for network-to-network transmission without having to modify the user packet (hence no checksum consequence), incur tunneling overheads, or incur allocation of in-between pre-computed buffers. Use of a trailer contract allows addition of new contracts (agreements), especially when transiting from network to network.

Contracts in any of the formats of FIG. 2 or other formats can provide, to a carrier, complete service-specific information. The contract embedded in a packet format is expected to meet the agreements at different layers to meet the requirements at that layer. A contract can not only describe the service, but can encapsulate incentives for different levels or dis-incentives on failures in addition to the expected level of performance. With this approach all layers can contribute in determining the outcome of service delivery.

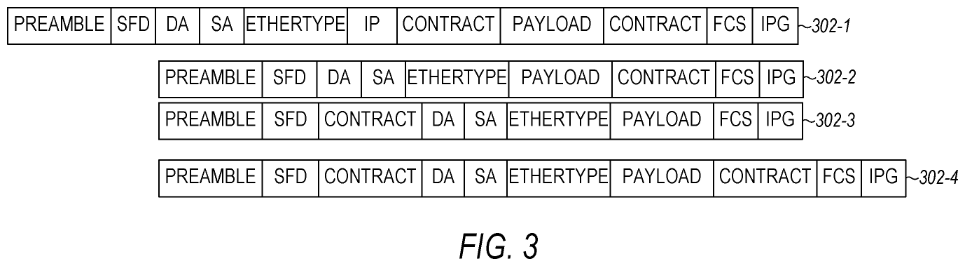

FIG. 3 shows embodiments of four example formats 302-1, 302-2, 302-3, and 302-4 that further illustrate different positioning of a contract in a frame/packet. Each of the formats 302-1, 302-2, 302-3, and 302-4 include, in addition to a contract, a preamble identifying that a frame is starting and enabling synchronization, a start frame delimiter (SFD), a destination address (DA), a source address (SA), a field (Ethertype) to indicate which protocol is encapsulated in the payload of the frame and is used at the receiving end by the data link layer to determine how the payload is processed, a payload, a frame check sequence (FCS) containing a cyclic redundancy check (CRC) that allows detection of corrupted data, and an interpacket gap (IPG) that is a time between packets. The format 302-1 also includes an identification of an IP. Such formats can be used with routers designed to perform packet processing in a layered approach using respective headers of each layer. The place for the contract can be determined by looking for a code or flag to indicate the presence of a contract structure. The code or flag can be implemented using a well-known code or flag that identifies that information is to be processed. For example, the contract structure in IP may follow immediately after the IP (v4 or v6) header, while in Ethernet, the contract structure may follow as a shim Ethertype field. The contract can be placed at the beginning or tail of the frame itself. For example, as shown in formats 302-2, 302-3, and 302-4 of FIG. 3, for an Ethernet frame, the contract can be placed immediately following the preamble and SFD and/or before the FCS. An L1 contract in the format should include its length. As a router scans incoming bits for the start of a frame, a L2 header, or a L3 header, the router can identify the presence of a contract and process the contract accordingly. Contracts can be presented as L1.5, L2.5, or L3.5, where 0.5 refers to an intermediate layer. A packet or frame can carry a contract that is just relevant at its level. For example, a L1.5 contract can be used at the fast-switched gateways to demand bandwidth transiting to a different administrative network.

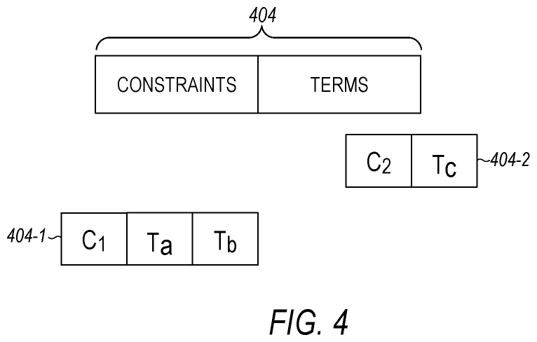

FIG. 4 illustrates an embodiment of an example of a basic structure for a contract to be embedded in a communication flow. A basic contract clause (CCL) 404 can include two types of components: constraints and terms. The contract constraints typically specify what service conditions, network resources, and metrics are to be met. More generally, the constraints indicate a condition that can be satisfied or not satisfied, and the condition can optionally be a service condition, a network state, a network resource usage level, and a metric, but the condition can also be other things. The contract terms specify operations type and thresholds of that service such as a number of packet drops or delayed packet delivery, which qualify as failure of service. The terms provide “what if” thresholds of service, in terms of incentives and dis-incentives associated with exceeding limits. The terms can be null to indicate absence of incentives or disincentives. There are different ways of describing the constraints in conventional approaches to communication. For example, in conventional approaches, constraints can be mapped to DiffServ, IntServ, or traffic-engineered paths. However, the second part of a contract, the terms of the contract, is a consequence of success or failure of service delivery not described in the data path. A contract in a communication flow can provide assurable type and customizable type functionality. The terms of the contract can enable a service to be accurately billable and accountable.

FIG. 4 also illustrates that a basic CCL 404 is not limited to a fixed number of terms. A CCL 404-1 is implemented as a CCL with a first constraint, C₁, and two terms, Ta and Tb. A CCL 404-2 is implemented as a CCL with a second constraint, C₂, and one term, Tc. A contract can be implemented as a combination of CCL 404-1 and CCL 404-2. In addition, constraints and terms are not limited to a particular number of constraints and terms. An overall contract can be implemented as a logical combination of CCLs. Each CCL can be a minimal standalone unit or result of logical operation on two or more CCLs. In such cases, the term subcontract can be used. An associated Boolean algebra on CCLs can be format specific. The structure of the contract can involve declarative means of expressing a contract. A CCL (subcontract) can indicate a particular type of characteristic (compute, monitor, billing, count, etc.) or network resource (delay, bandwidth) requirement. Use of contracts in a communication flow is depicted in the following examples.

A first example is a contract by a user having two CCLs. The two CCLs are referred to in the following as a subcontract (1) and a subcontract (2). The subcontract (1) is for HPC services with a latency guarantee of in-time performance of 15 ms and a throughput guarantee of 12 Mbps [Subcontract (1)=HPC(In-time 15 ms, bw: 12 Mbps)]. The subcontract (2) is for HPC services with a lossless networking guarantee having a start time of x and an end time of y [Subcontract(2)=Lossless (start_time=x, end_time=y)]. The term of the contract includes a penalty for the service provider that for a packet dropped, the provider will increment a credit to the account of the user with the provider [Term=if (pkt gets dropped) increment credit]. The contract is generated as the combination of the subcontract (1) and the subcontract (2) [Contract (User)=SubContract (User, 1) AND SubContract (User,2)].

A second example is a contract by a user and a network having two CCLs. The two CCLs are referred to in the following as a subcontract (user) associated with the user and a subcontract (ISP) associated with an ISP. The subcontract (user) is for HPC services with a latency guarantee of in-time performance of 15 ms and a throughput guarantee of 12 Mbps [Subcontract (user)=HPC (In-time 15 ms, bw: 12 Mbps)]. The subcontract (ISP) has a user-defined networking functionality that provides for preferred path with guarantees of reliability with the overall path made up of a first path, P1, and a second path, P2, where P1 includes communication flow over networks N1, N2, and N4 and P2 includes communication flow over networks N3, N6, and N8 [Subcontract(ISP)=PreferredPath (reliable, P1(N1, N2, N4), P2(N3, N6, N8))]. The contract is generated as a user contract having the combination of the subcontract (user) and the subcontract (ISP) [Contract (User)=Subcontract (User) AND Subcontract (ISP)].

A third example is a contract for video service from an application. A subcontract of the contract has a cost for premium service with a resolution of 1080p and no cost for free service with a resolution of 512 kbps [Subcontract=VS(Premium, res: 1080p); VS(free, res: 512 kbps)]. The contract includes a term that specifies billing to incur for jitter less than 30 ms and a credit to incur for jitter greater than 30 ms [Term=Bill(jitter <30) or Credit(jitter >30)]. The contract for the application has the components of the subcontract and the term [Contract(app)=(Subcontract AND Term)].

As demonstrated above, contracts can enable a number of capabilities on services offered in networks. Any format or language used to define contracts can adhere to a number of constructs. One construct for a contract is that the contract can be customizable. Customizable is a constraint type of a clause. It allows different services to be customized dynamically. A service provider can offer same video streaming with different resolution if the user is willing to accept the additional cost for better resolution. Different types of combination of services are offered, for example, premium and free for different types of video resolution. Examples include contract parties, delivery choices, and storage. Contract parties can include, but are not limited to, a global network service manager and an individual network service provider. Delivery choices can include, but are not limited to, as-scheduled and re-schedule of delivery time. Storage can include, but is not limited to, holding off at a designated router for later retrieval by a receiver within a certain time window.

Another construct for a contract is that the contract can be assurable. New HPC type services beyond-best effort services are becoming more and more resource dependent and guaranteed delivery dependent. Applications like those in an industry network need to know that a packet being delivered to a machine will arrive at the precise time. The network needs to assure that a packet carrying an assurable contract must reach its destination as per the description in the contract. HPC services can include parameters relating in-time, on-time, and lossless guarantees.

Another construct for a contract is that the contract can provide a user network interface. The user network interface can include parameters requesting specific network resources, for example, a specific path or minimum bandwidth.

Another construct for a contract is that the contract is billable. Today all data transiting several ISPs or staying in the same network is charged based on usage. The charge does not consider overall effort or network resources used to provide a service. For example, if a specific low latency resource path is requested by user, it may be appropriate to charge accordingly, which can be specified in the contract embedded in a packet. The bill payer can be a sender, a receiver, or the sender and the receiver using a splitting ratio between the sender and the receiver.

Another construct for a contract is that the contract is accountable. Typically, in current network procedures, when network congestion occurs, user packets on a bottleneck node are dropped indiscriminately. The accountable capability allows services, which are willing to be dropped or delayed, to claim a cost for the lost data, while services that pass through are willing to pay premiums. The accountable capability can include collection of sufficient number of packets for an aggregated delivery, which can avoid frequently waking up a receiver device. The accountable capability of a contract can include high-precision telemetry to track packets in a particular flow to determine, among other things, whether the packets are reaching their destination on time and whether throughput of the packets is not changing.

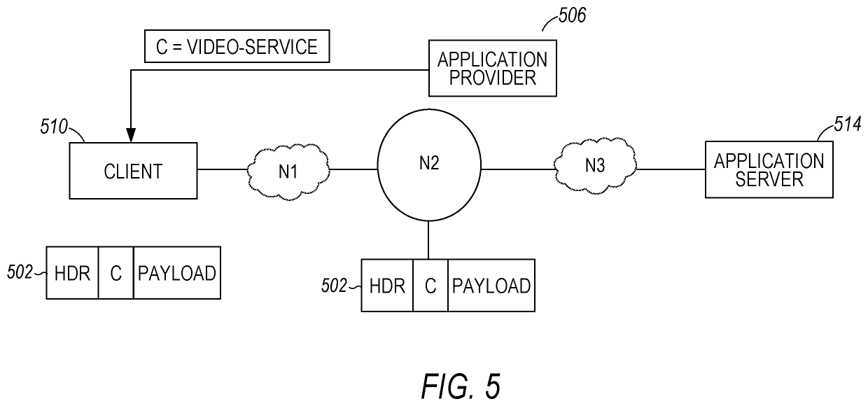

FIG. 5 illustrates an embodiment of an example method of transmitting a contract from an application provider 506 to an application server 514. This example relates to contracts inserted between layer 3 and layer 3.5. Other examples of embodiments can be related to layer 2 or other layers. In this example, the application provider 506 can provide a video-service contract C to a client 510. The client 510 can generate a packet 502 having a header (HDR), the video-service contract C, and a payload. The client 510 can transmit the packet 502 to the application server 514 using networks N1 and N3, and network node N2. The network node N2 can process the packet 502 with respect to the video-service contract C. For the video-service contract C having a jitter requirement, the network node N2 can determine if the jitter requirement is exceeded and generate a message to an accounting system to credit, bill, or maintain current charges to the client 510, depending on the results of the determination by the network node N2.

One or both of the network nodes N1 and N3 can include or have access to a database. The database can be a database including network contracts. On reception of the packet 502, the one or both of network nodes N1 and N3 can use its database to verify that the video-service contract C in the packet 502 is valid and from a valid trusted source/destination and should be honored or considered for honoring to be forwarded in a path to the application server 514 or processed at one or both of network nodes N1 and N3, before forwarding toward the application server 514, based on information in the database. In some instances, the CCLs of the video-service contract C can include an identification that one or both of the network nodes N1 and N3 can be rewarded for some specified behavior, with the database indicating that the packet's sender can be trusted to provide the reward.

The video-service contract C can be established at application login or start up time. For example, the application provider 506 can provide a clause to choose better video service when possible at premium. The charge can be shown as metadata in the video-service contract C. In this example, the term-component of the CCL can capture three outcomes. The first outcome can be normal service behavior at a normal charge. The second outcome can be degraded service with a credit to the user. The third outcome can be better service with a charge to the user, if permitted by the user, to allow better service when possible. For example, the contract can be established to keep jitter at 20 ms, with the term to add incentives and disincentives for degraded service for jitter higher than 20 ms, in which case, the account of the user will be credited. The video-service CCL can include constraints of the bandwidth being greater than or equal to 30 Mbps and jitter less than or equal to 20 ms. The video-service CCL can include terms of normal performance being acceptable, bandwidth not being met resulting in the service being free, and jitter exceeding 20 ms resulting in a credit of a specified amount to the client 510.

The network node N2 can include a database of network contracts that can be accessed to determine validity of contract clauses of the video-service contract C and inform a network controller with respect to the accountability associated with terms of the video-service contract C, in response to accessing the database. The network node N2 can use data in the packet 502, including data in metadata of the contract associated with the packet 502, to make determinations with respect to accountability. With respect to accountability, if the network node N2 cannot meet contract constraints, it can provide its identifier in metadata of terms of the video-service contract C in the packet 502. This will result in networks learning about problems in the networks, such as congestion, in which case, the networks may take additional corrective actions. The network nodes N1 and N3 can also access associated databases to determine accountability associated with the terms of the video-service contract C.

The example discussed above with respect to FIG. 5 generally concerns a user device to an application service direction of the flow. A similar contract or a different contract in the reverse direction can also be applied. Contracts, embedded in packets according to a communication layer for processing, may be sought by a consuming party or offered by a providing party.

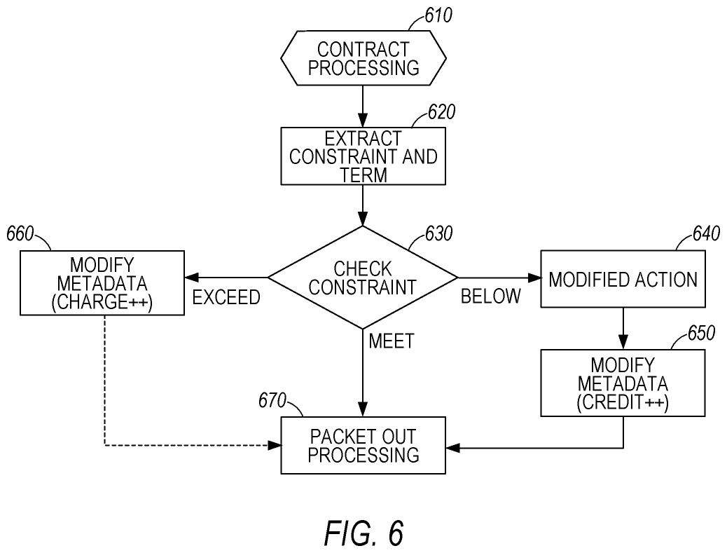

FIG. 6 is a flow diagram of an embodiment of example operations on a packet by a network node. The network node can identify the presence of a contract in the packet, evaluate conditions imposed on the packet by network events in the transmission path of the packet, and modify metadata in the contract in the packet. At 610, a network node begins processing the contract. The processing at the network node can be conducted by a router of the network node. A database of contracts at the network node or accessible by the network node can be accessed to perform a number of functions. The database of contracts can be used to verify that the contract is valid and from a valid trusted source/destination and should be honored. At 620, one or more constraints and one or more terms of the contract from the packet are processed. The database of contracts can be used to determine accountability associated with the terms of the contract, in response to analysis of the contract information obtained from accessing of the database. Accountability can include dis-incentives to network providers for failure to deliver, incentives to network providers for exceeding expectations in delivery, and can include no action taken when delivery is within the terms of the contract.

At 630, the one or more constraints are checked. If the result of the check identifies that the constraint is below the specified threshold of the contract, the service is degraded and modified action is taken, at 640. For example, if there is an unmet constraint such as jitter being higher than requested in the contract, then the service is below expectation and a credit increment is updated in metadata of the contract in the packet. With the modified action taken, metadata in the packet is modified to identify credit for the user, at 650. With the metadata modified with a credit, the packet is processed out from the network node, at 670. If service is provided to the packet that is better than normal, a user may be charged for this effort. If the result of the check, at 630, identifies that the constraint is above the specified threshold of the contract, better service is attained and metadata in the contract is modified to identify a charge to the user, at 660. With the metadata modified with a charge, the packet is processed out from the network node, at 670. Alternatively, or in conjunction with modifying metadata of the contract clause, one or more separate packets can be transmitted to an accounting node or accounting application, where the one or more separate packets report results of checking the constraint with respect to tracked network performance. The report can include identification of exceeding, not meeting, or meeting the constraint. The identification of exceeding can include being above or below a specified threshold, depending on the particular constraint evaluated. The report can also include associated amounts associated with exceeding or not meeting the constraint. If the contract is processed normally, the packet is forwarded without any change, at 670.

A contract system control plane can be implemented to distribute, validate, assess feasibility, and negotiate contract agreements between parties involved. Contracts may be sought by a consuming party or offered by a providing party. A combination of control plane with availability of a contract in packets can allow for robust network service delivery models.

A user can choose a preferred path for end-to-end delivery, given that the path only contains service providers with whom the sender, the receiver, or both the sender and the receiver have contracts. Thus, the contract can be set up end-to-end, which means a contract could be composed of multiple subcontracts with different network service providers. Two alternative deployments can be used for contract initialization for an end-to-end contract.

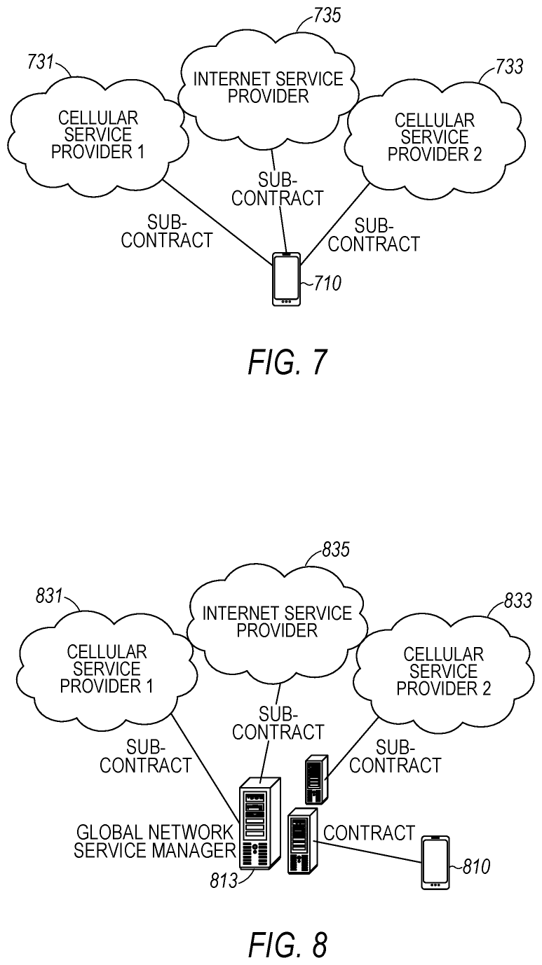

FIG. 7 illustrates an embodiment of an example end-to-end contract setup with individual network service providers. A device 710 initiates a contract with each involved network service provider, such as a first cellular service provider 731, an Internet service provider 735, and a second cellular service provider 733, on a preferred path for end-to-end packet delivery purpose. Therefore, depending on a receiver device, there could be multiple subcontracts between the device 710 and each one of the first cellular service provider 731, the Internet service provider 735, and the second cellular service provider 733. In this approach, the device 710 is aware of each subcontract, resulting in the billing being transparent to the device 710. The contracts are more flexible between the device 710 and each of the first cellular service provider 731, the Internet service provider 735, and the second cellular service provider 733. Each subcontract is validated immediately by each of the first cellular service provider 731, the Internet service provider 735, and the second cellular service provider 733, once a packet carrying the contract enters the respective domain, which does not involve any third party in the process. However, this approach has the device 710 setting up the contract individually with each of the involved network service providers. In addition, with a subcontract being dynamic, frequent setups can occur according to a receiver location and a contract level or specification. Since the subcontracts are composed at the device side, some operational overhead could be incurred by the device 710.

FIG. 8 illustrates an embodiment of an example an end-to-end contract setup with providers established through a global network service (GNS) manager proxy. In this approach, a device 810 only initializes a contract with the GNS manager 813 that communicates with involved network service providers such as a first cellular service provider 831, an Internet service provider 835, and a second cellular service provider 833. Use of the GNS manager 813 as a proxy can hide, from the device 810, the details of subcontract decomposition, the identity of the involved network service providers, the charging rate, and billing from each network service provider. The device 810 can be operable to only interface with the GNS manager 813 for setting up and terminating the contract. There can exist multiple contracts from the same device 810 with different contract specifications. In addition, there is much less overhead at the device side, for example, subcontract composition, subcontract decomposition, and billing. However, in this approach, the contract is set up with less flexibility since the device 810 can only set up the service packages and contract specifications that are provided by the GNS manager 813. Everything that happens beyond the GNS manager 813 is opaque to the device 810, which may not be preferable for some devices requiring transparence. When packet delivery proceeds, the subcontract is to be validated between the current network service provider and the GNS manager 813, when the packet enters the current domain of the current network service provider.

With the help of control plane and other management-level mechanisms, a subscriber can have an account associated with a long-term contract. The account can have negotiated pricing with the network service provider for different kinds of services. The account can have a prepaid fund and a predefined fund accessibility, in which only the account holder is able to bill to the account, receivers of packets sent by the account holder are able to bill to the account, and authorized users of the account are able to bill to the account.

The account holder can be a sender or receiver for packet delivery purpose. As a sender, the account holder can specify how the packets, originated from itself, are delivered in the contract specification. As a receiver, the account holder can specify how the packets, destined to itself, are delivered in the contract specification. For example, when network congestion occurs, the packets destined to this receiver with a special contract with the service provider can have higher priority than other packets.

Approaches such as self-driving packets or big packet protocol (BPP) packets provide a data plane programmability model that can be used to implement a contract to cover a subset of functionality at layer 2.5 or layer 3.5. In comparison to a contract as taught herein, such self-driving packets or BPP approaches are an instruction-based “imperative data plane programming” approach that network devices can process. Contracts are an overarching approach in the sense that they allow both declarative as well as imperative embodiments. In a declarative model, how service guarantees are fulfilled is not specified in terms of instruction; an altogether different grammar can be devised. Then, each party may implement or validate through different means.

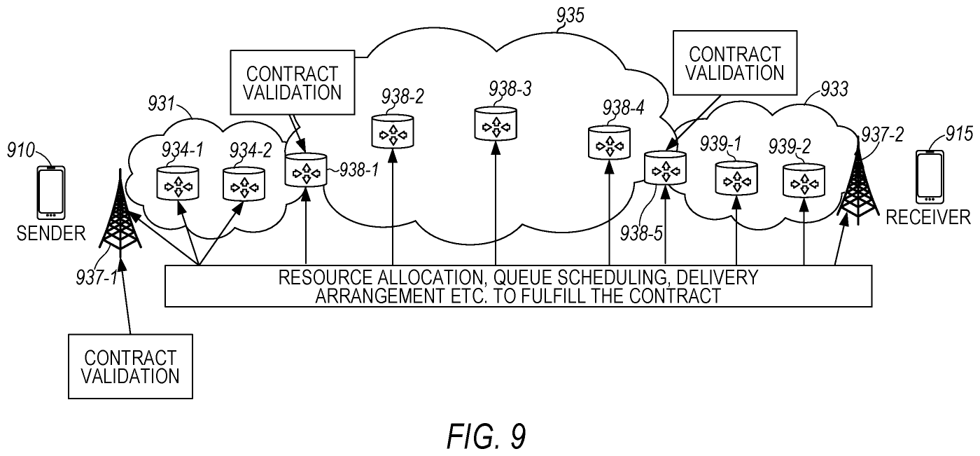

FIG. 9 illustrates an embodiment of an example of end-to-end contract validation and execution. In this example, a sender 910 sends packets containing a contract to a receiver 915 through networks 931, 935, and 933. The transmission from the sender 910 to the network 931 is provided by a radio base station 937-1, where the contract is validated. Packets flow through the network 931 to an entry network node 938-1 to the network 935 along a path that includes network nodes 934-1 and 934-2. At the radio base station 937-1 and the network nodes 934-1, 934-2, and 938-1, these network nodes can perform resource allocation, queue scheduling, delivery arrangement, and other functions to fulfill the contract. At the network node 938-1 that is an ingress point of the network 935, the contract is again validated. The packets proceed to flow through the network 935 to an exit network node 938-5 of the network 935 along a path that also includes network nodes 938-2, 938-3, and 938-4. At the network nodes 938-2, 938-3, 938-4, and 938-5, these network nodes can perform resource allocation, queue scheduling, delivery arrangement, and other functions to fulfill the contract. The exit network node 938-5 of the network 935 is also an ingress point to the network 933. At the network node 938-5, the contract is again validated. The packets proceed to flow through the network 933 from the network node 938-5 to a radio base station 937-2 along a path that also includes network nodes 939-1 and 939-1. At the network nodes 939-1, 939-2, and radio base station 937-2, these network nodes can perform resource allocation, queue scheduling, delivery arrangement, and other functions to fulfill the contract. A database of contracts can be associated with each of the above network nodes to perform contract validation or to make determinations with respect to accountability.

In the example of FIG. 9, the contract is validated at the ingress point of each network service provider's domain, either with a GNS manager or with the current network service provider in the flow. The contract can be fulfilled hop-by-hop by each network node, with actions such as resource allocation, queue scheduling, delivery arrangement, and other functions.

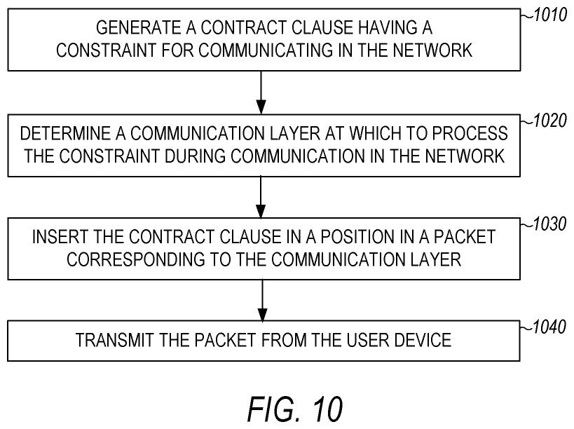

FIG. 10 is a flow diagram of features of an embodiment of an example method 1000 of a user device communicating in a network. The method 1000 can be realized by one or more processors executing instructions stored in one or more memory storage devices of the user device. At 1010, a contract clause having a constraint for communicating in the network is generated. The contract clause can have a number of features or combinations of features. The contract clause can encapsulate service functionality including customization, assurance, accountability, or billability. The constraint can specify a network resource to be used or a metric to be met during the communication in the network. The contract clause can include a term specifying a parameter associated with the constraint, a threshold for the parameter, and an action to be taken in response to measuring the parameter and determining that the measured parameter exceeds a threshold. Depending on the parameter, determining that the measured parameter exceeds a threshold can include evaluating the measured parameter with respect to the threshold as to whether the measured parameter is above or below the threshold. The parameter can be an operation type, which is a function embedded in the terms part of the contract. The function is to be performed under the conditions specified and evaluated as to whether service constraints are either met or not. The contract clause can encapsulate service functionality including customization, assurance, accountability, or billability. The constraint can be customizable for a set of parameters and the action can include one or more of a billable action, an accountability action, and an assurance action.

At 1020, a communication layer at which to process the constraint during communication in the network is determined. At 1030, the contract clause is inserted in a position in a packet corresponding to the communication layer. For example, insertion at L1.5 can include requirements regarding time synchronization of two endpoints or latency between two endpoints. Insertion at L2.5 can include requirements regarding latency between two endpoints. Insertion at L3.5 can include requirements regarding such services as high-precision service and deterministic throughput. The packet can include one or more additional contract clauses inserted in positions corresponding to different communication layers. At 1040, the packet is transmitted from the user device. Though contracts typically will be inserted by a user device, in some embodiments the mechanism for inserting a contract can be a lower layer communication component. A network node can also insert a contract for a peering network to process.

Variations of the method 1000 or methods similar to the method 1000 can include a number of different embodiments that may be combined depending on the application of such methods and/or the architecture of systems in which such methods are implemented. Such methods can include processing a second contract clause in a received packet from a second network, originating from another device, according to a communication layer in which the second contract clause is embedded in the received packet; and performing a function specified in the second contract clause. The second network can be the network into which the user device transmitted the packet with the embedded contract.

Variations of the method 1000 or methods similar to the method 1000 can include the communication layer being between a physical and a media access layer, between the media access layer and a network layer, or between the network layer and a transport layer. The packet can include one or more additional contract clauses. The one or more additional contract clauses can be inserted in positions corresponding to one or more different communication layers. The variations can include the contract clause being part of a network contract specified for a group of packets, a flow, or a group of flows.

Variations of the method 1000 or methods similar to the method 1000 can include the network including different domain networks in an end-to-end communication path, and the packet including one or more additional contract clauses, with each additional clause directed to a service in a respective different domain network. Variations can include, before communication, agreeing with the different domain networks to fulfill contracts in the networks when packets from the user device pass through. Other variations can include, before communication, agreeing with a global network controller of the different domain networks through which the packets transit, the global network controller having one or more network subcontracts with each of the domain networks on behalf of the user device.

In various embodiments, a non-transitory machine-readable storage device, such as computer-readable non-transitory media, can comprise instructions stored thereon, which, when performed by a machine, cause the machine to perform operations, where the operations comprise one or more features similar to or identical to features of methods and techniques described with respect to the method 1000, variations thereof, and/or features of other methods taught herein such as associated with the Figures herein. The physical structures of such instructions may be operated on by one or more processors. Executing these physical structures can cause the machine to perform operations. A non-transitory computer-readable media storing computer instructions for a user device communicating in a network, that when executed by one or more processors, can cause the one or more processors to perform operations comprising: generating a contract clause having a constraint for communicating in the network; determining a communication layer at which to process the constraint during communication in the network; inserting the contract clause in a position in a packet corresponding to the communication layer; and transmitting the packet from the user device.

In various embodiments, a user device can be operable to communicate in a network. The user device can comprise a memory storing instructions and one or more processors in communication with the memory. The one or more processors can execute the instructions to: generate a contract clause having a constraint for communicating in the network; determine a communication layer at which to process the constraint during communication in the network; insert the contract clause in a position in a packet corresponding to the communication layer; and transmit the packet from the user device. The contract clause can be part of a network contract specified for a single packet, a group of packets, a flow, or a group of flows. The contract clause can encapsulate service functionality including customization, assurance, accountability, or billability. The one or more processors of the user device can also be operable to execute the instructions to: process a second contract clause in a received packet from a network, originating from another device, according to a communication layer in which the second contract clause is embedded in the received packet; and perform a function specified in the second contract clause. The second network can be the network into which the user device transmitted the packet having an embedded contract, when the user device operated as an originator of the contract.

The constraint can specify a network resource to be used or a metric to be met during the communication in the network. The contract clause can include a term specifying a parameter associated with the constraint, a threshold for the parameter, and an action to be taken in response to measuring the parameter and determining that the measured parameter exceeds a threshold.

Variations of such a user device or similar user devices can include a number of different embodiments that may be combined depending on the application of such user devices and/or the architecture in which such user devices are implemented. Such user devices can include the communication layer being between a physical layer and a media access layer, between the media access layer and a network layer, or between the network layer and a transport layer. Other variations can include a packet including one or more additional contract clauses. The one or more additional contract clauses can be inserted in positions corresponding to one or more different communication layers.

Variations of such a user device can include the user device operable with the network including different domain networks in an end-to-end communication path. The packet can include one or more additional contract clauses, with each additional clause directed to a service in a respective different domain network. The one or more processors can be operable to, before communication, have agreed with the different domain networks to fulfill contracts in the different domain networks when packets from the user device pass through. In addition, or in the alternative, the one or more processors can be operable to, before communication, have agreed with a global network controller of the different domain networks through which the packets transit. The global network controller can have one or more network subcontracts with each of the domain networks on behalf of the user device.

In various embodiments, a user device can be implemented to communicate in a network using contracts embedded in packets. Such a user device can include a means for generating a contract clause having a constraint for communicating in the network and a means for determining a communication layer at which to process the constraint during communication in the network. The user device can include a means for inserting the contract clause in a position in a packet corresponding to the communication layer and a means for transmitting the packet from the user device. Though contracts will typically be inserted in a packet by a user device, in some embodiments, the means for inserting a contract in a packet can be a lower layer communication. A network node can also insert a contract in a packet for a peering network to process. The constraint can specify a network resource to be used or a metric to be met during the communication in the network. The contract clause can include a term specifying a parameter associated with the constraint, a threshold for the parameter, and an action to be taken in response to measuring the parameter and determining that the measured parameter exceeds a threshold. The contract clause can encapsulate service functionality including customization, assurance, accountability, or billability. The contract clause can be part of a network contract specified for a single packet, a group of packets, a flow, or a group of flows. The network contract can include one or more additional contract clauses. The packet can include one or more additional contract clauses inserted in positions corresponding to one or more different communication layers. The communication layer can be between a physical layer and a media access layer, between the media access layer and a network layer, or between the network layer and a transport layer.

In such a user device, the means for generating a contract clause having a constraint for communicating in the network can include a capability for generating one or more additional contract clauses for the network including different domain networks within the network in an end-to-end communication path, with each additional clause directed to a service in a respective different domain network. Such a user device can, before communication, have agreed with the different domain networks to fulfill contracts in the networks when packets from the user device pass through. Such a user device can, before communication, have agreed with a means for globally controlling a network of the different domain networks through which the packets transit, with the means for globally controlling the network having one or more network subcontracts with each of the domain networks and distributing the network subcontracts on behalf of the user device.

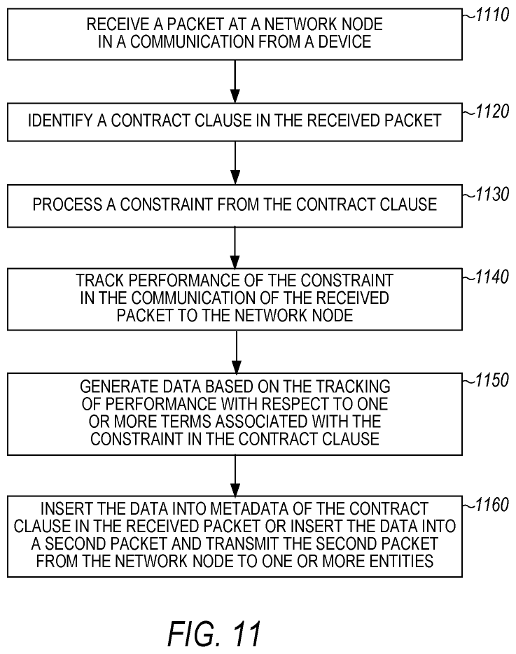

FIG. 11 is a flow diagram of features of an embodiment of an example method 1100 of a network node communicating in a network. The method 1100 can be realized by one or more processors of the network node executing instructions stored in one or more memory storage devices of the network node. At 1110, a packet is received at a network node in a communication from a device. At 1120, a contract clause in the received packet is identified. When the packet enters the network node, it can be directed through processing modules at each communication layer. The processing module at each communication layer can determine whether the contract is present or not at that communication layer. At 1130, a constraint from the contract clause is processed. The contract clause can be processed by executing actions specified in the constraints of the contract clause. Such actions can include, but are not limited to, forwarding the packet in a preferred path, determining if the packet meets an in-time guarantee or an on-time guarantee, or scheduling further transmissions to meet an in-time guarantee or an on-time guarantee. Other actions, such as determining or evaluating network performance, can be taken in processing the contract clause. Processing the constraint from the contract clause can be conducted at a communication layer dependent upon position of the contract clause in the packet.

At 1140, performance of the constraint in communication of the received packet to the network node can be tracked. The tracking can include determining or evaluating network performance with respect to one or more constraints in the received packet for one or more portions of the communication path taken by the packet to the network node. At 1150, data is generated based on the tracking of performance with respect to one or more terms associated with the constraint in the contract clause. Generating data based on the tracking of performance can include generating the data from determining a degraded status of performance. The data can include an amount of credit for billing based on the degraded status. Generating data based on the tracking of performance can include generating the data from determining an enhanced status of performance, with the data including an amount of increase in billing. With a contract having one or more contract clauses with one or more constraints such that there are multiple terms, the generated data can include determination of one or more degraded statuses and one or more enhanced statuses. The generated data can also include associated credits and debits.

At 1160, the data is inserted into metadata of the contract clause in the received packet or the data is inserted into a second packet and the second packet is transmitted from the network node to one or more entities. After inserting the data into metadata of the contract clause in the received packet, the received packet can be forwarded to its destination. The destination can be at the network node, another network node, an application, an end user, or other entity.

Variations of the method 1100 or methods similar to the method 1100 can include a number of different embodiments that may be combined depending on the application of such methods and/or the architecture of systems in which such methods are implemented. Such methods can include accessing a database containing network contracts; determining a validity status of the contract clause based on contract data obtained from accessing the database; and informing a network controller or the device with respect to the determined validity status. Variations of such methods can include validating the contract clause at the network node when the network node is an edge node of a network in a communication path from the device.

In various embodiments, a non-transitory machine-readable storage device, such as computer-readable non-transitory media, can comprise instructions stored thereon, which, when performed by a machine, cause the machine to perform operations, where the operations comprise one or more features similar to or identical to features of methods and techniques described with respect to the method 1100, variations thereof, and/or features of other methods taught herein such as associated with the Figures herein. The physical structures of such instructions may be operated on by one or more processors. Executing these physical structures can cause the machine to perform operations. A non-transitory computer-readable media storing computer instructions for a network node communicating in a network, that when executed by one or more processors, can cause the one or more processors to perform operations comprising: receiving a packet at the network node in a communication from a device; identifying a contract clause in the received packet; processing a constraint from the contract clause; tracking performance of the constraint in the communication of the received packet to the network node; generating data based on the tracking of performance with respect to one or more terms associated with the constraint in the contract clause; and inserting the data into metadata of the contract clause in the received packet or inserting the data into a second packet and transmitting the second packet from the network node to one or more entities.

In various embodiments, a network node can comprise a memory storing instructions and one or more processors in communication with the memory. The one or more processors execute the instructions to identify a contract clause in a packet received at the network node in a communication from a device and process a constraint from the contract clause. The processing of the constraint from the contract clause can be conducted at a communication layer dependent upon position of the contract clause in the packet. The one or more processors execute the instructions to track performance of the constraint in the communication of the packet from the device to the network node and to generate data based on the tracking of performance with respect to one or more terms associated with the constraint. The one or more processors execute the instructions to insert the data into metadata of the contract clause in the packet or insert the data into a second packet and transmit the second packet from the network node to one or more entities.

The generated data from the tracking of performance can be a result of a determination of a degraded status of performance. The data can include an amount of credit for billing. In addition, or in the alternative, the generated data can include a result of a determination of an enhanced status of performance, with the data including an amount of increase in billing.

Variations of such a network node or similar network nodes can include a number of different embodiments that may be combined depending on the application of such network nodes and/or the architecture in which such network nodes are implemented. Such network nodes can include the one or more processors being operable to: access a database containing network contracts; determine a validity status of the contract clause based on contract data obtained from accessing the database; and inform a network controller or the device with respect to the determined validity status. Variations can include the one or more processors being operable to validate the contract clause when the network node is an edge node of a network in a communication path from the device.

In various embodiments, a network node can be implemented to process received packets having embedded contracts in the packets. The network node can include a means for identifying a contract clause in a packet received at the network node in a communication from a device, and a means for processing a constraint from the contract clause. The network node can include a means for tracking performance of the constraint in the communication of the packet from the device to the network node and a means for generating data based on the tracking of performance with respect to one or more terms associated with the constraint. The network node can include a means for inserting the data into metadata of the contract clause in the packet or inserting the data into a second packet. The second packet can be transmitted from the network node to one or more entities.

The means for generating data can provide a result of a determination of a degraded status of performance. Along with the degraded status, the means for generating data can include an associated amount of credit for billing. The means for generating data can also provide a result of a determination of an enhanced status of performance, with the result having data including an amount of increase in billing.

Such a network node can include the means for processing the constraint from the contract clause being conducted at a communication layer dependent upon position of the contract clause in the received packet. Such a network node can include a means for accessing a database containing network contracts, a means for determining a validity status of the contract clause based on contract data obtained from accessing the database, and a means for informing a network controller or the device with respect to the determined validity status. The network node can be, but is not limited to, an edge node of one network of one or more networks in a communication path from the device.

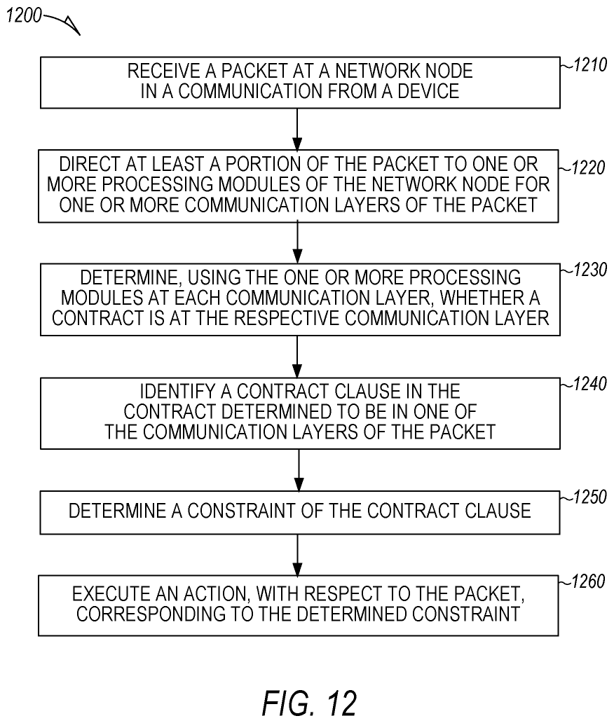

FIG. 12 is a flow diagram of features of an embodiment of an example method 1200 of a network node operating in a network. The method 1200 can be realized by one or more processors of the network node executing instructions stored in one or more memory storage devices of the network node. At 1210, a packet is received at the network node in a communication from a device. At 1220, at least a portion of the packet is directed to one or more processing modules of the network node for each communication layer of the packet. At 1230, using the one or more processing modules at each communication layer, a determination is made as to whether a contract is at a respective communication layer. At 1240, a contract clause in the contract, determined to be in one of the communication layers of the packet, is identified. At 1250, a constraint of the contract clause is determined. At 1260, an action is executed, with respect to the packet, corresponding to the determined constraint.

Variations of the method 1200 or methods similar to the method 1200 can include a number of different embodiments that may be combined depending on the application of such methods and/or the architecture of systems in which such methods are implemented. Such methods can include, in response to determining the constraint in the contract clause, tracking performance of the constraint in the communication of the packet from the device to the network node and generating data based on the tracking of performance with respect to one or more terms associated with the constraint. Data can be inserted into metadata of the contract clause in the packet or inserted into a second packet. The second packet can be transmitted from the network node to one or more entities.

Variations of the method 1200 or methods similar to the method 1200 can include accessing a database containing network contracts and determining a validity status of the contract clause based on contract data obtained from accessing the database. The database can include capabilities of the networks being used in the communication of the packet received at the network node. A network controller or the device can be informed with respect to the determined validity status. Variations can include informing the network controller or the device that the constraint cannot be met.

Variations of the method 1200 or methods similar to the method 1200 can also include determining an alternative contract with one or more associated terms. The alternative contract can be embedded in a return packet, and the return packet can be transmitted, directed to an originating device of the contract with respect to the packet received in the communication.

In various embodiments, a non-transitory machine-readable storage device, such as computer-readable non-transitory media, can comprise instructions stored thereon, which, when performed by a machine, cause the machine to perform operations, where the operations comprise one or more features similar to or identical to features of methods and techniques described with respect to the method 1200, variations thereof, and/or features of other methods taught herein such as associated with the Figures herein. The physical structures of such instructions may be operated on by one or more processors. Executing these physical structures can cause the machine to perform operations. A non-transitory computer-readable media storing computer instructions for a network node communicating in a network, that when executed by one or more processors, can cause the one or more processors to perform operations comprising: receiving a packet at the network node in a communication from a device and directing at least a portion of the packet to one or more processing modules of the network node for one or more communication layers of the packet. The operations also comprise determining, using the one or more processing modules at each communication layer, whether a contract is at the communication layer, and identifying a contract clause in the contract determined to be in one of the communication layers of the packet. The one or more processors perform operations comprising determining a constraint of the contract clause, and executing an action, with respect to the packet, corresponding to the determined constraint.

In various embodiments, a network node comprises a memory storing instructions and one or more processors in communication with the memory. The one or more processors execute the instructions to direct at least a portion of a packet, received at the network node in a communication from a device, to one or more processing modules of the network node for each communication layer of the packet. The one or more processors execute the instructions to determine, using the one or more processing modules at each communication layer, whether a contract is at the respective communication layer and to identify a contract clause in the contract determined to be in one of the communication layers of the packet. The one or more processors execute the instructions to determine a constraint of the contract clause and to execute an action, with respect to the packet, corresponding to the determined constraint.

Variations of such a network node or similar network nodes can include a number of different embodiments that may be combined depending on the application of such network nodes and/or the architecture in which such network nodes are implemented. Such network nodes can include, in response to determining the constraint in the contract clause, the one or more processors being operable to track performance of the constraint in the communication of the packet from the device to the network node and generate data based on the tracking of performance with respect to one or more terms associated with the constraint. The one or more processors can also be operable to insert the data into metadata of the contract clause in the packet or to insert the data into a second packet and transmit the second packet from the network node to one or more entities.

Variations of such a network node or similar network nodes can include the one or more processors being operable to access a database containing network contracts and determine a validity status of the contract clause based on contract data obtained from accessing the database. The one or more processors can inform a network controller or the device with respect to the determined validity status. Such variations can include the one or more processors being operable to inform a network controller or the device that the constraint cannot be met. Further variations can include the one or more processors being operable to determine an alternative contract with one or more associated terms; embed the alternative contract in a return packet; and transmit the return packet directed to an originating device of the contract with respect to the packet received in the communication.

In various embodiments, a network node can be implemented to process received packets having embedded contracts in the packets. The network node can include a means for directing at least a portion of a packet, received at the network node in a communication from a device, to one or more processing modules of the network node for each communication layer of the packet and a means for determining, using the one or more processing modules at each communication layer, whether a contract is at the respective communication layer. The network node can include a means for identifying a contract clause in the contract determined to be in one of the communication layers of the packet and a means for determining a constraint of the contract clause. The network node can execute an action, with respect to the packet, corresponding to the determined constraint.

The network node can include a means for tracking performance of the constraint in the communication of the packet from the device to the network node and a means for generating data based on the tracking of performance with respect to one or more terms associated with the constraint. The network node can include a means for inserting the data into metadata of the contract clause in the packet or inserting the data into a second packet. The second packet can be transmitted from the network node to one or more entities.

The network node can include a means to access a database containing network contracts and a means to determine a validity status of the contract clause based on contract data obtained from accessing the database. The network node can inform a network controller or the device with respect to the determined validity status. In some situations, the network node can inform a network controller or the device that the constraint cannot be met. The network node can also include a means for determining an alternative contract with one or more associated terms and can embed the alternative contract in a return packet. The network node can transmit the return packet directed to an originating device of the contract with respect to the packet received in the communication.

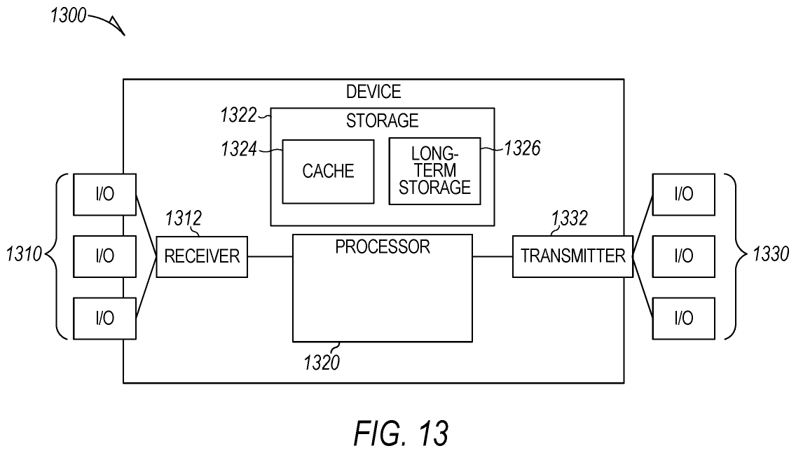

FIG. 13 shows an example embodiment of a node 1300 in accordance with embodiments of the disclosure. The node, which can be realized as a router in various arrangements, can transmit and receive data (e.g., a new IP packet) to and from at least one electronic device and/or a server, such as electronic device and/or a server 126 of FIG. 1, through a network (e.g., a global network), such as the network 130 of FIG. 1. The node 1300 can transmit the new IP packet, which is received through the network, to another electronic device 110 through a local network. Additionally, the node 1300 can transmit a new IP packet, which is received from the other electronic device, to the electronic device or the server 126 through the network. The node can also use other IP packets, such as IPv4 and IPv6 packets.

In an embodiment, the node 1300 can comprise a plurality of input/output ports 1310/1330 and/or receivers (Rx) 1312 and transmitters (Tx) 1332 for receiving and transmitting data from other nodes, a processor 1320 including an address translation circuit to process data and determine which node to send the data, and a storage 1322 including a cache 1324 and a long-term storage 1326. The long-term storage 1326 can include a database of contracts to verify that a contract is valid and from a valid trusted source/destination and should be honored or considered for honoring. The database of contracts can be used to determine accountability associated with terms of the contract, in response to the access of the database. Although illustrated as a single processor, the processor 1320 is not so limited and can comprise multiple processors. The processor 1320 can be implemented as one or more central processing unit (CPU) chips, cores (e.g., a multi-core processor), field-programmable gate arrays (FPGAs), application specific integrated circuits (ASICs), and/or digital signal processors (DSPs), and/or can be part of one or more ASICs. The processor 1320 can be configured to implement any of the schemes described herein using any one or combination of steps described in the embodiments. Moreover, the processor 1320 can be implemented using hardware, software, or both.

The storage 1322 (or memory) can include the cache 1324 and the long-term storage 1326, and can be configured to store routing tables, forwarding tables, or other tables or information disclosed herein. Although illustrated as a single storage, the storage 1322 can be implemented as a combination of read only memory (ROM), random access memory (RAM), or secondary storage (e.g., one or more disk drives or tape drives used for non-volatile storage of data).

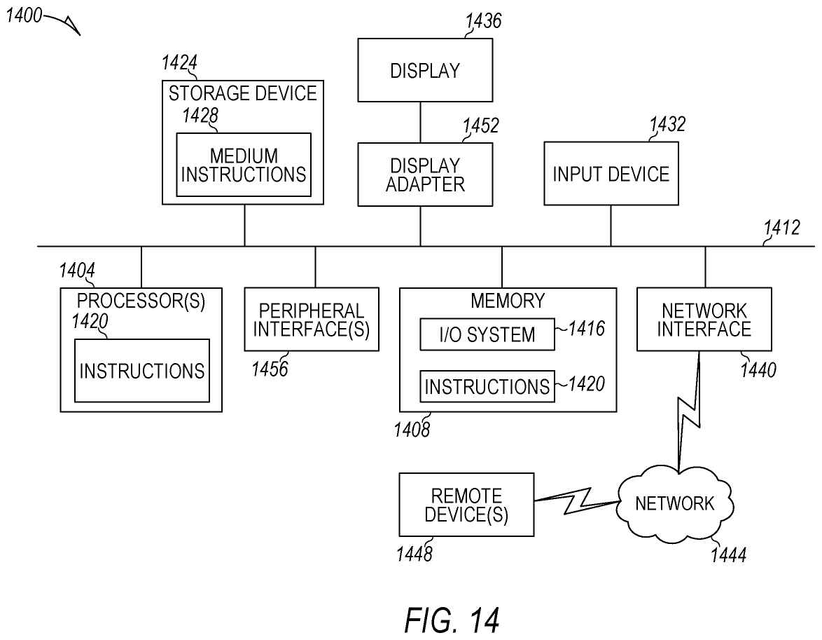

FIG. 14 shows an example embodiment of a computing system 1400 for implementing embodiments of the disclosure. The computing system 1400 can include a processor 1404 and a memory 1408 that communicate with each other, and with other components, via a bus 1412. The bus 1412 can include any of several types of bus structures including, but not limited to, a memory bus, a memory controller, a peripheral bus, a local bus, and any combinations thereof, using any of a variety of bus architectures.

The memory 1408 can include various components (e.g., machine-readable media such as computer-readable media) including, but not limited to, a random-access memory component, a read only component, and any combinations thereof. In an example, a basic input/output system 1416 (BIOS), including basic routines that help to transfer information between elements within computing system 1400, such as during start-up, can be stored in the memory 1408. The memory 1408 can also include (e.g., stored on one or more machine-readable media) instructions (e.g., software) 1420 embodying any one or more of the aspects and/or methodologies of the present disclosure. In another example, the memory 1408 can further include any number of program modules including, but not limited to, an operating system, one or more application programs, other program modules, program data, and any combinations thereof.

The computing system 1400 can also include a storage device 1424. Examples of a storage device, for example the storage device 1424, can include, but are not limited to, a hard disk drive, a magnetic disk drive, an optical disc drive in combination with an optical medium, a solid-state memory device, and any combinations thereof. The storage device 1424 can be connected to the bus 1412 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In an example, the storage device 1424, or one or more components thereof, can be removably interfaced with the computing system 1400, for example, via an external port connector (not shown). Particularly, the storage device 1424 and an associated machine-readable medium 1428 can provide nonvolatile and/or volatile storage of machine-readable instructions, data structures, program modules, and/or other data for the computing system 1400. In an example, the software 1420 can reside, completely or partially, within the machine-readable medium 1428. In another example, the software 1420 can reside, completely or partially, within the processor 1404.

Computing system 1400 can also include an input device 1432. In one example, a user of the computing system 1400 can enter commands and/or other information into the computing system 1400 via the input device 1432. Examples of the input device 1432 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. The input device 1432 can be interfaced to the bus 1412 via any of a variety of interfaces (not shown) including, but not limited to, a serial interface, a parallel interface, a game port, a USB interface, a FIREWIRE interface, a direct interface to the bus 1412, and any combinations thereof. The input device 1432 can include a touch screen interface that can be a part of or separate from a display 1436, discussed further below. The input device 1432 can be utilized as a user selection device for selecting one or more graphical representations in a graphical interface as described above.

A user can also input commands and/or other information to the computing system 1400 via the storage device 1424 (e.g., a removable disk drive, a flash drive, etc.) and/or a network interface device 1440. A network interface device, such as the network interface device 1440, can be utilized for connecting the computing system 1400 to one or more of a variety of networks, such as a network 1444, and one or more remote devices 1448 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as the network 1444, can employ a wired and/or a wireless mode of communication. In general, any network topology can be used. Information (e.g., data, the software 1420, etc.) can be communicated to and/or from the computing system 1400 via the network interface device 1440.

The computing system 1400 can further include a video display adapter 1452 for communicating a displayable image to a display device, such as the display 1436. Examples of a display device include, but are not limited to, a liquid crystal display (LCD), a cathode ray tube (CRT), a plasma display, a light emitting diode (LED) display, and any combinations thereof. The video display adapter 1452 and the display 1436 can be utilized in combination with the processor 1404 to provide graphical representations of aspects of the present disclosure. In addition to a display device, the computing system 1400 can include one or more other peripheral output devices including, but not limited to, an audio speaker, a printer, and any combinations thereof. Such peripheral output devices can be connected to the bus 1412 via a peripheral interface 1456. Examples of a peripheral interface include, but are not limited to, a serial port, a USB connection, a FIREWIRE connection, a parallel connection, and any combinations thereof.

A contract can be implemented in a packet or frame to define network services used by applications, which are provided by one or more networks as well as the conditions for a service assurance agreement. Innovative implementation of a contract in a packet or frame can include placement of contract specification in the packet or frame that can be associated with processing levels at network nodes. The innovative implementation can include the design or structure of the contract specification in the packet or frame that can include constraints and terms. Flexible grained terms enable identification of each packet that does not get serviced as per contract. Specification of formal terms helps proper accounting of service violations that can identify which node missed the target.

A contract can be set up between a device, an application on a device, a flow, a packet, and network service providers. For a device, a contract can apply to any packet delivery initialized from or destined to the device. For an application, a contract can be structured to only apply to packet delivery initialized from or destined to a particular application of a device. For a flow, a contract can be structured to only apply to packet delivery of a particular flow initialized from or destined to a particular application of a device. For a packet, a contract can be structured to only apply to a particular packet delivery initialized from or destined to a device. A contract can be set up at any communication level. For whatever communication level, the contract can be initialized from a device, which can negotiate a contract for all packet deliveries, for packet delivery for a particular application, for packet delivery for a particular flow, or packet delivery for a particular packet from or to the device.

As taught herein, a contract level for a device, application, flow, or packet can be set up for contract parties and validation that can include a GNS manager or individual network service providers. The contract can be established with a bill payer that can include a sender, a receiver, or both the sender and receiver using a splitting ratio between the sender and the receiver. As taught herein, clauses of a contract can include a number of components. Such components can include but are not limited to in-time specifications for guaranteed delivery deadline, on-time specifications for exact delivery time, bandwidth specifications for guaranteed end-to-end bandwidth. Component specifications can include delivery choices such as as-scheduled, re-schedule of delivery time, hold off at a designated location for later retrieval by a receiver device within a certain time window, and collection of enough number of packets for an aggregated delivery, which can avoid frequently waking up a receiver device. The contract structure can also allow for extended services providing options applicable to expand to new network services.

The present subject matter may be embodied in many different forms and should not be construed as being limited to the embodiments set forth herein. Indeed, the subject matter is intended to cover alternatives, modifications, and equivalents of these embodiments, which are included within the scope of the subject matter. Furthermore, in the detailed description of the present subject matter, numerous specific details are set forth to provide a thorough understanding of the present subject matter. However, it will be clear to those of ordinary skill in the art that the present subject matter may be practiced without such specific details.

Machine-readable storage media, such as computer-readable storage media (medium), exclude (excludes) propagated signals per se, can be accessed by a computer and/or processor(s), and include(s) volatile and non-volatile internal and/or external media that is removable and/or non-removable. For a computer, the various types of storage media accommodate the storage of data in any suitable digital format. Other types of computer-readable medium can be employed such as zip drives, solid state drives, magnetic tape, flash memory cards, flash drives, cartridges, and the like, for storing computer-executable instructions for performing the novel methods (acts) of the disclosed architecture.

The description of the present disclosure has been presented for purposes of illustration and description, but is not intended to be exhaustive or limited to the disclosure in the form disclosed. Modifications and variations will be apparent to those of ordinary skill in the art without departing from the scope of the disclosure. For purposes of this document, each process associated with the disclosed technology may be performed continuously and by one or more computing devices. Each step in a process may be performed by the same or different computing devices as those used in other steps, and each step need not necessarily be performed by a single computing device.

Although specific embodiments have been illustrated and described herein, it will be appreciated by those of ordinary skill in the art that any arrangement that is calculated to achieve the same purpose may be substituted for the specific embodiments shown. Various embodiments use permutations and/or combinations of embodiments described herein. It is to be understood that the above description is intended to be illustrative, and not restrictive, and that the phraseology or terminology employed herein is for the purpose of description. Combinations of the above embodiments and other embodiments will be apparent to those of skill in the art upon studying the above description.

What is claimed is:

1. A user device operable to communicate in a network, the user device comprising:
a memory storing instructions; and
one or more processors in communication with the memory, wherein the one or more processors execute the instructions to:
generate a contract clause having a constraint for communicating in the network;
determine a communication layer at which to process the constraint during communication in the network;
insert the contract clause in a position in a packet corresponding to the communication layer; and
transmit the packet from the user device.

2. The user device of claim 1, wherein the one or more processors are operable to execute the instructions to:
process a second contract clause in a received packet from a network, originating from another device, according to a communication layer in which the second contract clause is embedded in the received packet; and
perform a function specified in the second contract clause.

3. The user device of claim 1, wherein the constraint specifies a network resource to be used or a metric to be met during the communication in the network.

4. The user device of claim 1, wherein the contract clause includes a term specifying a parameter associated with the constraint, a threshold for the parameter, and an action to be taken in response to measuring the parameter and determining that the measured parameter exceeds a threshold.

5. The user device of claim 1, wherein the contract clause encapsulates service functionality including customization, assurance, accountability, or billability.

6. The user device of claim 1, wherein the communication layer is between a physical and a media access layer, between the media access layer and a network layer, or between the network layer and a transport layer.

7. The user device of claim 1, wherein the packet includes one or more additional contract clauses.

8. The user device of claim 7, wherein the one or more processors execute the instructions to insert the one or more additional contract clauses into positions corresponding to one or more different communication layers.

9. The user device of claim 1, wherein the network includes different domain networks in an end-to-end communication path, and the packet includes one or more additional contract clauses, with each additional clause directed to a service in a respective different domain network.

10. The user device of claim 9, wherein the one or more processors are operable to, before communication, have agreed with the different domain networks to fulfill contracts in the networks when packets from the user device pass through.

11. The user device of claim 9, wherein the one or more processors are operable to, before communication, have agreed with a global network controller of the different domain networks through which the packets transit, the global network controller having a network subcontract with each of the domain networks on behalf of the user device.

12. The user device of claim 1, wherein the contract clause is part of a network contract specified for a group of packets, a flow, or a group of flows.

13. A computer-implemented method of a user device communicating in a network, the computer-implemented method comprising:
generating a contract clause having a constraint for communicating in the network;
determining a communication layer at which to process the constraint during communication in the network;
inserting the contract clause in a position in a packet corresponding to the communication layer; and
transmitting the packet from the user device.

14. The computer-implemented method of claim 13, wherein the method includes:
processing a second contract clause in a received packet from a network, originating from another device, according to a communication layer in which the second contract clause is embedded in the received packet; and
performing a function specified in the second contract clause.

15. The computer-implemented method of claim 13, wherein the constraint specifies a network resource to be used or a metric to be met during the communication in the network.

16. The computer-implemented method of claim 13, wherein the contract clause includes a term specifying a parameter associated with the constraint, a threshold for the parameter, and an action to be taken in response to measuring the parameter and determining that the measured parameter exceeds a threshold.

17. The computer-implemented method of claim 13, wherein the contract clause encapsulates service functionality including customization, assurance, accountability, or billability.

18. The computer-implemented method of claim 13, wherein the communication layer is between a physical and a media access layer, between the media access layer and a network layer, or between the network layer and a transport layer.

19. The computer-implemented method of claim 13, wherein the packet includes one or more additional contract clauses.

20. The computer-implemented method of 19, wherein the one or more additional contract clauses are inserted in positions corresponding to one or more different communication layers.
